(19) United States
(12) Patent Application Publication
(10) Pub. No.: US 2019/0075758 A1
(43) Pub. Date: Mar. 14, 2019

(54) PET THERAPY JACKET

(71) Applicant: Myron Ward, Rochester, MN (US)

(72) Inventor: Myron Ward, Rochester, MN (US)

(21) Appl. No.: 15/661,032

(22) Filed: Sep. 13, 2017

(51) Int. Cl. A01K 13/00; A61H 23/02

(52) U.S. Cl. CPC A01K 13/006; A61H 23/02

(57) ABSTRACT

A pet therapy jacket comprising a harness configured for positioning on a torso of the pet wherein the harness comprises one or more pockets, each pocket configured to receive a one or more of a massaging element and a heating element. The jacket further comprises a controller operably connected to each of the massaging elements and heating elements inserted into the pockets. The controller has an interface for selectively activating the massaging elements and heating elements to provide therapy to the pet.

### SUMMARY

The present disclosure relates to a therapy jacket for an animal, such as a dog. The therapy jacket is a harness having one or more pockets which each hold a device, such as a massaging element, configured to provide selected pressure to a zone surrounding the pocket. This selected pressure provides a massage to the animal wearing the jacket in the corresponding zone. The therapy jacket may further comprise one or more heating elements positioned in one or more pockets for also providing heat to the corresponding zone.

The therapy jacket includes a controller and power source each operably connected to the respective massage element and/or heating element. The controller includes an interface allowing the operator to select the zones in which to activate the massage and/or heating element.

The therapy jacket is also washable as the massage and heating elements as well as the controller are removable from the jacket.

### BRIEF DESCRIPTION OF THE DRAWINGS

FIG. 1 is a right side view of a pet jacket positioned on a dog.

FIG. 2 is a left side view of the pet jacket positioned on the dog.

FIG. 3 is a top view of the pet jacket and accessory control device.

FIG. 4 is a view of a controller for the pet jacket.

### DETAILED DESCRIPTION

A pet therapy jacket is illustrated generally in the figures at 10. The pet therapy jacket 10 is a harness 12 that is designed to massage dogs. The pet therapy jacket 10 is intended to treat dogs in need of therapy, such as treating aching muscles, pain, decreasing anxiety, increasing relaxation, and treating injured dogs.

The pet therapy jacket has five zones 13 to target. These zones 13 are located on pockets 14 of the harness 12. There is a controller 16, and a power cord 18 that is connected to the harness 12. Additionally, the harness 12 has straps 20, comprised of hook and loop fasteners (e.g., Velcro®) and the harness 12 is also washable.

The power cord 18 connected to the harness 12 controller 16 has to be plugged into an outlet to provide power for the massage and other settings. The harness 12 should also be operated under adult supervision at all times. Adult supervision is recommended for the safety and well-being of the animal.

The controller 16 is programmed to cause vibration in the pockets 14 of the harness 12. There are five zone buttons 22 on the controller 16 which will allow an operator to target the area of their choice on the pet wearing the harness 12. The controller 16, power cord 18, and vibrator elements 24 are removable from the harness 12 to allow the harness 12 itself to be washed.

In addition, a “Heat Control” controller 26 is an additional accessory provided on the harness 12 or in one or more pockets 14 that will cause the same areas, when controlled by an adult, to get warm in the target areas. The pet jacket 12 is not a toy. It is a device designed for the treatment of dogs.

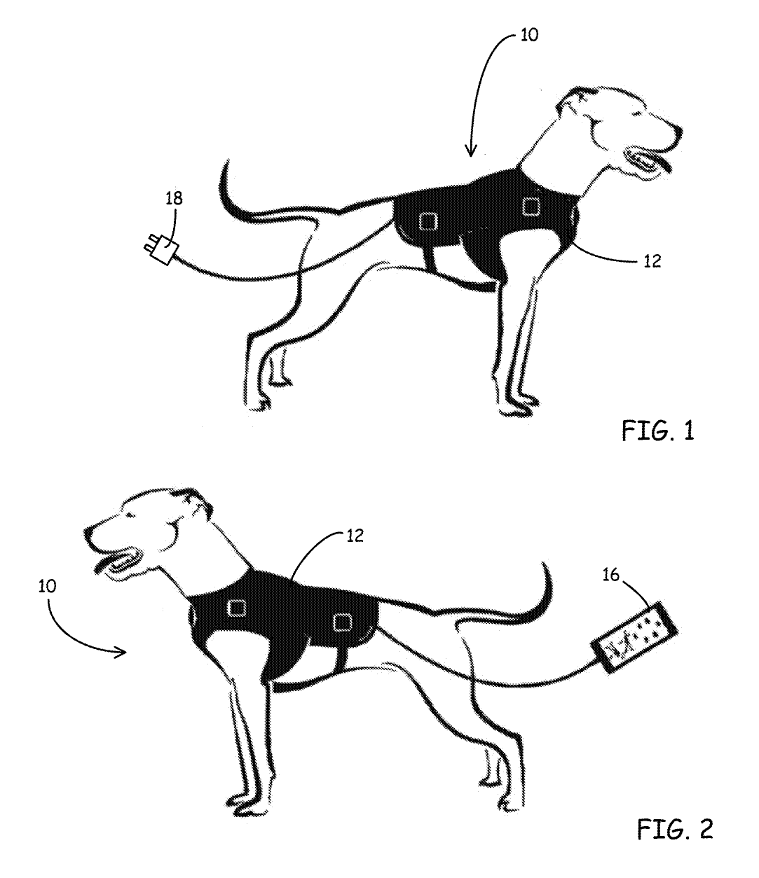

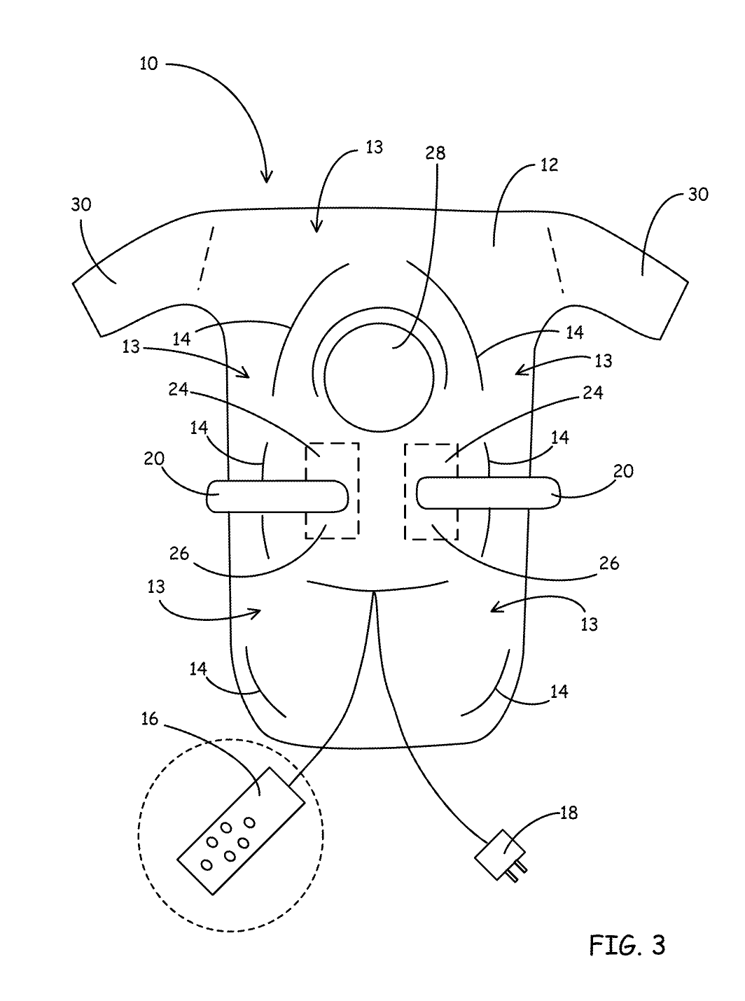

As illustrated in FIGS. 1-3, the harness 12 is configured to fit on the animal such that the harness 12 comprises an opening 28 for the head of the animal to fit there through and comprises arm portions 30 that wrap around the animal and are secured by hook and loop fasteners to secure the jacket 10 around the torso of the animal.

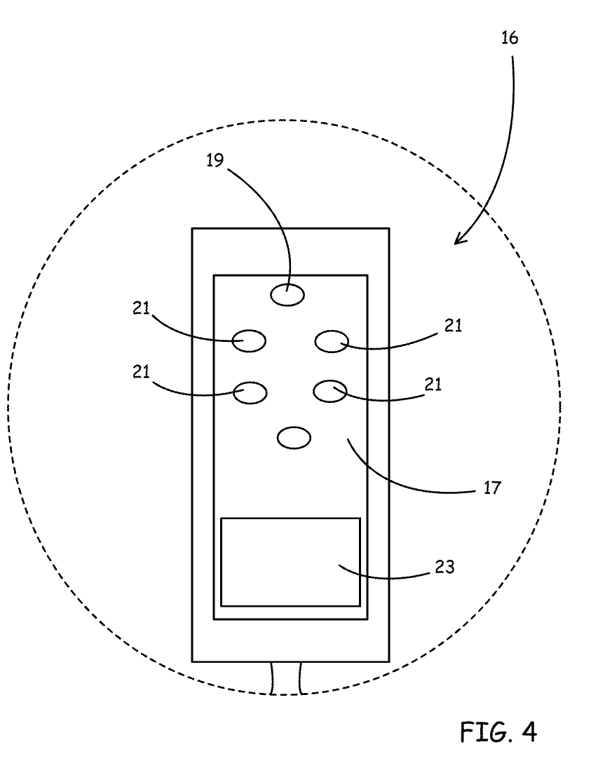

As illustrated in further detail in FIG. 4, the controller 16 is configured with an interface 17 for using the controller to provide selected massage and/or heat to the jacket 10 and thus the animal wearing the jacket 10 at one or more of the zones 13. The interface includes a push-button 19 for powering the massage and/or heat control settings and separate push-buttons 21 for stopping and starting the massage and/heat in each one of the zones 13. Additional information such as a status can be displayed in display box 23 on the interface.

The jacket 12 is comprised of a flexible material that can be wrapped around the animal allowing the animal wear the jacket 10.

Although the present disclosure has been described with reference to preferred embodiments, workers skilled in the art will recognize that changes may be made in form and detail without departing from the spirit and scope of the disclosure.

What is claimed is:

1. A pet therapy jacket comprising:
a harness configured for positioning on a torso of the pet wherein the harness comprises:
one or more pockets, each pocket configured to receive a one or more of a massaging element and a heating element;
a controller operably connected to each of the massaging elements and heating elements inserted into the pockets and wherein the controller has an interface for selectively activating the massaging elements and heating elements to provide therapy to the pet.

2. The pet therapy jacket of claim 1 wherein the harness comprises five pockets and each pocket is positioned in a zone such that the massage element or heating element provide therapy in the corresponding zone.

3. The pet therapy jacket of claim 1, wherein the one or more of the massaging element and the heating element are removable from the jacket so that the jacket is washable.

4. The pet therapy jacket of claim 1, wherein the harness further comprises straps having a hook and loop fastener system for securing the jacket around the torso of the pet for providing therapy to the pet.

5. A method of providing a therapy to a pet comprising:
positioning a harness on a torso of the pet wherein the harness comprises one or more pockets;
placing one or more of a massaging element and a heating element in one or more of the pockets;
providing a controller operably connected to each of the massaging elements and heating elements placed into the pockets;
using an interface of the controller to selectively activating the massaging elements and heating elements for providing therapy to the pet.

6. The method of claim 5 and further securing the jacket on the torso of the pet by securing straps fixed to the harness around the torso of the pet.

7. The method of claim 5 and further comprising removing the jacket from the pet and removing the massaging and heating elements from the pockets and removing the controller form the harness for washing the jacket.

8. The method of claim 5 and further comprising plugging in the controller and massage and heating elements to a wall outlet via a power cord operably connected to the controller and massage and heating elements for activating the massage and heating elements with the controller.
